(19) United States
(12) Patent Application Publication
(10) Pub. No.: US 2024/0032561 A1
(43) Pub. Date: Feb. 1, 2024

(54) Protein-Enriched Marshmallows

(71) Applicant: Michael Segrest, Key West, FL (US)

(72) Inventor: Michael Segrest, Key West, FL (US)

(21) Appl. No.: 18/360,298

(22) Filed: Jul. 27, 2023

Related U.S. Application Data
(60) Provisional application No. 63/369,537, filed on Jul. 27, 2022.

(51) Int. Cl. A23G 3/44; A23L 29/10; A23P 30/40; A23L 29/212; A23L 33/15; A23L 29/262

(52) U.S. Cl. CPC A23G 3/44; A23L 29/10; A23P 30/40; A23L 29/212; A23L 33/15; A23L 29/262

(57) ABSTRACT

Protein-enriched marshmallow formulations providing average adults with enough protein to maximize muscle-protein synthesis and nutritional ingestion processes for about 3-hour periods of time. Also, such marshmallows formulations can effectively absorb and deliver a variety of combinations of fortified water-soluble and/or fat-soluble vitamins and minerals nutritionally beneficial to humans of all ages.

### CROSS-REFERENCE TO RELATED APPLICATIONS

This Application claims the benefit of the filing date of U.S. Provisional Patent Application Ser. No. 63/369,537, filed Jul. 27, 2022, the entire content of which is herein incorporated.

### BACKGROUND OF THE INVENTION

### 1. Field of Invention

The present invention pertains generally to protein-enriched confectionery products and, more particularly, to the field of protein-enriched marshmallows.

### 2. Description of the Related Art

Years ago, marshmallows were a sweetened paste made from the root of a mallow. Current marshmallows are a confectionery made from sugar (or corn syrup), water and gelatin. The mixture is whipped to a solid-but-soft consistency and may be used as a filling in baking or molded into shapes and then coated with corn starch.

While people have eaten marshmallows as a confectionery for many years, marshmallows have traditionally relied upon sugar-based carbohydrates including corn syrup to maintain a marshmallow's fluffy physical configuration and structure. Sugar-based formulas infuse marshmallows with relatively high caloric content, relative to caloric content of food recommended by board certified nutritionists, while providing people only relatively minor amounts of micronutrients and macronutrients of any nutritional benefit, based upon amounts of marshmallows that are consumed. Traditional marshmallows are sugar-based, contain almost no fat, and contain no protein. Sugar-substitute formulas contain less sugar and no fat, and also no protein.

A need is still felt for protein-enriched marshmallow products that reduce hunger and sugar cravings for individuals wishing, for example, to lose weight.

### SUMMARY OF THE INVENTION

The objective of the present invention is to provide protein-enriched marshmallow products and methods of producing the same.

Disclosed herein are various example embodiments of the present general inventive concept. Protein-based marshmallows as described herein provide an average adult with enough protein to maximize the muscle-protein synthesis process for about a 3-hour period of time. Also, they provide a serving size of about 56 grams (86% higher than a traditional marshmallow 30-gram serving) while only containing about 98 calories per serving. Also, since my protein-based marshmallow formulations rely upon a fat-to-emulsifier combination (i.e., weight ratio) to maintain their structural integrity, marshmallows made from my formulations can effectively absorb and deliver a wide assortment of combinations of fortified water/fat-soluble vitamins and minerals to the human body.

Thus, in some example embodiments of the present general inventive concept, a protein-enriched marshmallow composition includes water, protein, gelatin, an emulsifier, and a preservative agent. In some embodiments, the protein is whey protein.

In some embodiments, the emulsifier includes at least one emulsifier selected from the group consisting of lecithin, lactic acid esters of mono and diglycerides, acetic acid esters of mono and diglycerides, polyglycerol esters, propylene glycol esters, polypropylene glycol esters, sucrose esters, lecithin, cellulose gum, microcrystalline cellulose, hydroxypropyl methylcellulose (HPMC), monoglycerides, and diglycerides, modified cellulose, lactic acid esters of mono- and di-glycerides, polysorbate 80, calcium stearoyl-2-lactylate, lactylic stearate, sodium stearoyl fumarate, and sodium stearoyl-2-lactylatewhey protein. In some embodiments, the emulsifier specifically includes polysorbate 80.

In some embodiments, the protein-enriched marshmallow composition includes 20-30 grams water, 18-24 grams protein, 4-5 grams gelatin, and 1-3 grams emulsifier.

In some embodiments, the protein-enriched marshmallow composition further includes up to 3 grams artificial sweetener; up to 3 grams of flavoring agent; up to 3 grams corn starch; and/or up to 6 grams of vitamin and/or mineral supplements.

In some example embodiments of the present general inventive concept, a method of producing a protein-enriched marshmallow comprises: mixing gelatin, water, and a preservative agent to form a water-preservative-gelatin mixture, the mass ratio of water to gelatin being at least 2.5:1; after allowing gelatin within the water-preservative-gelatin mixture to absorb water within the water-preservative-gelatin mixture, heating the water-preservative-gelatin mixture to a temperature of 45 degrees Celsius to 65 degrees Celsius; mixing protein, artificial sweetener, and food-grade emulsifier to form a protein-sweetener-emulsifier mixture; combining the water-preservative-gelatin mixture with the protein-sweetener-emulsifier mixture and mixing thoroughly to form a marshmallow mixture; cooking the marshmallow mixture to remove water until water content of the marshmallow mixture is from 25% to 35% of the total mass of the marshmallow mixture; heating the marshmallow mixture at a temperature of 50 degrees Celsius to 55 degrees Celsius; aerating the marshmallow mixture; and extruding the aerated marshmallow mixture onto a corn starch bed.

Some embodiments further comprise the step, before combining the water-preservative-gelatin mixture with the protein-sweetener-emulsifier mixture, adding liquid flavoring to the water-preservative-gelatin mixture.

Some embodiments further comprise the step, before combining the water-preservative-gelatin mixture with the protein-sweetener-emulsifier mixture, adding at least one vitamin to the water-preservative-gelatin mixture.

In some embodiments of the described method, the protein includes whey protein powder.

In some embodiments of the described method, the emulsifier includes at least one emulsifier selected from the group consisting of lecithin, lactic acid esters of mono and diglycerides, acetic acid esters of mono and diglycerides, polyglycerol esters, propylene glycol esters, polypropylene glycol esters, sucrose esters, lecithin, cellulose gum, microcrystalline cellulose, hydroxypropyl methylcellulose (HPMC), monoglycerides, and diglycerides, modified cellulose, lactic acid esters of mono- and di-glycerides, polysorbate 80, calcium stearoyl-2-lactylate, lactylic stearate, sodium stearoyl fumarate, and sodium stearoyl-2-lactylate.

In some embodiments, the emulsifier specifically includes polysorbate 80.

Further benefits and advantages of the present invention will become apparent after a careful reading of the detailed description.

### DETAILED DESCRIPTION

Reference will now be made to the example embodiments of the present general inventive concept, examples of which are described below. The example embodiments are described herein in order to explain the present general inventive concept.

In accordance with the present general inventive concept, there is provided formulations for protein-enriched marshmallow compositions and products along, with methods of producing the same.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Replacing digestible sugar-based carbohydrates usually found in marshmallow formulations with protein-containing ingredients transforms an otherwise traditional marshmallow formulation, by providing the formulation with a much better nutritional profile for humans of all ages seeking to increase micronutrient and macronutrient intake. Such replacement increases protein intake, thereby improving the body's cellular replication rate, while reducing sugar intake. Such replacement also may enable people to maintain their desired body weight and/or nutritional intake. Moreover, instead of relying upon sugar to maintain a marshmallow's shape, size, and other physical properties, using an increased (yet still relatively minor) amount of fat combined with an assortment of predetermined amounts of emulsifiers to maintain traditional marshmallow physical properties, allows marshmallows to be potentially infused with a variety of combinations of vitamins and minerals that will improve micronutrient content.

Table 1 presents a summary of approximate ingredient proportions for a protein-enriched marshmallow according to one example embodiment of the present general inventive concept:

TABLE 1

| Item | Ingredient | Amount | Comments |
|---|---|---|---|
| 1 | water | 20-30 | Provides solvent for other |
| | | grams | formulation ingredients. |
| 2 | whey | 18-24 | Increases protein content of |
| | protein/casein | grams | formulation, adds fat. |
| | protein (or other | | |
| | protein additive) | | |
| 3 | gelatin | 4-5 grams | Provides the formulation with a |
| | | | continuous protein chain, while |
| | | | increasing formulation protein content |
| 4 | artificial | 0-3 grams | Adds sweetness to formulation. |
| | sweetener | | |
| 5 | emulsifier | 1-3 grams | Aids the gelatin in forming a more |
| | | | viscous structure. Also allows fat in |
| | | | whey to dissolve in aqueous mix. |
| 6 | corn starch | 1-3 grams | Reduces stickiness of outer layer of |
| | | | product made |
| 7 | preservative | 0-1 gram | Increases shelf-life of marshmallow |
| | | | product made. |
| 8 | vitamin/mineral | 0-6 grams | Increases product macronutrient |
| | supplements | | content, if added. |
| 9 | natural/artificial | 0-3 grams | Effective amount is added to provide |
| | flavors | | desired flavor |

The addition of whey protein increases the protein content of the formulation mixture. In addition, the whey protein provides the mixture with a relatively minor amount of fat. The additional, relatively minor, amount of fat advantageously allows the mixture to effectively deliver a variety of fat-soluble vitamins and/or minerals to the body. The gelatin content of formulations of the present subject matter is much higher than current marshmallow formulations. In embodiments of the present subject matter, the gelatin ingredient combines with water to provide formulations of the present subject matter with a protein chain that creates a base for replacing the sugar-based carbohydrate chains that would otherwise ordinarily provide traditional marshmallows with their physical properties.

The sugar alcohol-to-natural sweetener-to-artificial sweetener combinations of the present general inventive concept enable marshmallows made from my protein-enriched marshmallow formulations to provide humans with enough sweetness to remove an otherwise unreasonable desire to satisfy a sweetness craving. Indeed, ingesting controlled amounts of the protein-enriched marshmallows of the present subject matter may satisfy many urges to eat throughout one's day.

The emulsifier ingredient helps to strengthen the physical configuration, cohesiveness, and overall structure of protein-enriched marshmallows made in accordance with formulation of the present subject matter, while also allowing the otherwise hydrophobic fat ingredient to combine with the water-based formulation.

The corn starch ingredient keeps individual protein-enriched marshmallow units from sticking together in the packaging. An effective amount of the preservative ingredient increases the shelf life of the formulation and individual protein-enriched marshmallow units, while packaged. Various vitamin-to-mineral combinations of ingredients of the present subject matter, when added to disclosed formulations, will enable formulation manufacturers, after consulting with board certified nutritionists, to deliver micronutrient supplements nutritionally beneficial to humans of all ages. Effective amounts of the flavoring ingredient provide palate pleasure to consumers.

### EXAMPLE

Water, preservative, and gelatin, combined in a weight ratio of 2.5:1 or greater (depending on bloom quality), is allowed to “bloom” (which is a process whereby the gelatin ingredient absorbs the water). When this process has completed, the water/gelatin/preservative mixture is heated to a temperature of between about 45-65 degrees Celsius (° C.).

Next, protein, artificial sweetener, and food-grade emulsifier ingredients are combined and homogenously mixed together, preferably with high shear, and retained in dry form.

Liquid flavoring and any vitamins and preservatives, if used, are added to the water/gelatin/preservative mixture, at a temperature of between 45-65° C., and mixed homogenously.

Thereafter, the dry mixture of whey protein powder, sweeteners, and emulsifier is added to the gelatin/vitamin/flavoring liquid mixture. All ingredients are mixed homogenously. The resulting mixture is cooked at mixing temperature for an amount of time that is effective to reduce water content of the mixture to 25-35% of total mass. Next, temperature of the mixture is increased or reduced to about 50-55° C.

The final mixture is aerated to increase volume of the mixture to 1.7 to 2.0 of its original volume. Next, the aerated mixture is moved into an extruder and immediately extruded onto a corn starch bed. The resulting protein-enriched marshmallows are then cut, to achieve a desired size, and thereafter are packaged.

Water, whey protein, gelatin, sweeteners, and at least one food-grade emulsifier are essential ingredients in the manufacture of my protein-enriched marshmallow products. Vitamin supplements, preservatives, flavoring are optional.

Food-grade emulsifiers are used to provide stability and homogeneity to protein-enriched marshmallow products, making it easier to combine ingredients for a desired structure. Various known food-grade emulsifiers include and is not limited to, lecithin (from eggs or soy), lactic acid esters of mono and diglycerides, acetic acid esters of mono and diglycerides, polyglycerol esters, propylene glycol esters, polypropylene glycol esters, sucrose esters, lecithin, cellulose gum, microcrystalline cellulose, hydroxypropyl methylcellulose (HPMC), monoglycerides (of fatty acids), and diglycerides (of fatty acids), modified cellulose, lactic acid esters of mono- and di-glycerides (of fatty acids), polysorbate 80, calcium stearoyl-2-lactylate, lactylic stearate, sodium stearoyl fumarate, and sodium stearoyl-2-lactylate, among others.

A common food-grade emulsifier is polysorbate 80 (having a chemical formula of C₆₄H₁₂₄O₂₆; a molar mass of 1,310 grams per mole; and a solubility in water of 100 milliliters per liter) which is used as an emulsifier in many foods. For example, in ice cream, polysorbate 80 is added up to 0.5% (v/v) concentration to make ice cream smoother and easier to handle, as well as increasing its resistance to melting. Adding this emulsifier prevents the milk proteins from completely coating fat droplets.

Various example embodiments of the present general inventive concept provide a protein-enriched marshmallow composition comprising water, protein, gelatin, an emulsifier, and a preservative agent.

In some embodiments, the protein is whey protein.

In some embodiments, the emulsifier includes at least one emulsifier selected from the group consisting of lecithin, lactic acid esters of mono and diglycerides, acetic acid esters of mono and diglycerides, polyglycerol esters, propylene glycol esters, polypropylene glycol esters, sucrose esters, lecithin, cellulose gum, microcrystalline cellulose, hydroxypropyl methylcellulose (HPMC), monoglycerides, and diglycerides, modified cellulose, lactic acid esters of mono- and di-glycerides, polysorbate 80, calcium stearoyl-2-lactylate, lactylic stearate, sodium stearoyl fumarate, and sodium stearoyl-2-lactylatewhey protein.

In some embodiments, the emulsifier includes polysorbate 80.

In some embodiments, the protein-enriched marshmallow composition includes 20-30 grams water, 18-24 grams protein, 4-5 grams gelatin, and 1-3 grams emulsifier.

In some embodiments, the protein-enriched marshmallow composition includes up to 3 grams artificial sweetener.

In some embodiments, the protein-enriched marshmallow composition includes up to 3 grams of flavoring agent.

In some embodiments, the protein-enriched marshmallow composition includes up to 3 grams corn starch.

In some embodiments, the protein-enriched marshmallow composition includes up to 6 grams of a vitamin.

In some embodiments, the protein-enriched marshmallow composition includes up to 6 grams of a mineral supplement.

In some embodiments, the protein-enriched marshmallow composition includes up to 6 grams of vitamin and/or mineral supplements.

Various example embodiments of the present general inventive concept provide a method of producing a protein-enriched marshmallow comprising: mixing gelatin, water, and a preservative agent to form a water-preservative-gelatin mixture, the mass ratio of water to gelatin being at least 2.5:1; after allowing gelatin within the water-preservative-gelatin mixture to absorb water within the water-preservative-gelatin mixture, heating the water-preservative-gelatin mixture to a temperature of 45 degrees Celsius to 65 degrees Celsius; mixing protein, artificial sweetener, and food-grade emulsifier to form a protein-sweetener-emulsifier mixture; combining the water-preservative-gelatin mixture with the protein-sweetener-emulsifier mixture and mixing thoroughly to form a marshmallow mixture; cooking the marshmallow mixture to remove water until water content of the marshmallow mixture is from 25% to 35% of the total mass of the marshmallow mixture; heating the marshmallow mixture at a temperature of 50 degrees Celsius to 55 degrees Celsius; aerating the marshmallow mixture; and extruding the aerated marshmallow mixture onto a corn starch bed.

Some embodiments further comprise the step, before combining the water-preservative-gelatin mixture with the protein-sweetener-emulsifier mixture, adding liquid flavoring to the water-preservative-gelatin mixture.

Some embodiments further comprise the step, before combining the water-preservative-gelatin mixture with the protein-sweetener-emulsifier mixture, adding at least one vitamin to the water-preservative-gelatin mixture.

In some embodiments of the described method, the protein includes whey protein powder.

In some embodiments of the described method, the emulsifier includes at least one emulsifier selected from the group consisting of lecithin, lactic acid esters of mono and diglycerides, acetic acid esters of mono and diglycerides, polyglycerol esters, propylene glycol esters, polypropylene glycol esters, sucrose esters, lecithin, cellulose gum, microcrystalline cellulose, hydroxypropyl methylcellulose (HPMC), monoglycerides, and diglycerides, modified cellulose, lactic acid esters of mono- and di-glycerides, polysorbate 80, calcium stearoyl-2-lactylate, lactylic stearate, sodium stearoyl fumarate, and sodium stearoyl-2-lactylate.

In some embodiments, the emulsifier includes polysorbate 80.

Thus, from the foregoing it may be seen that various example embodiments of the present general inventive concept provide protein-enriched marshmallow products and methods of producing the same.

### INDUSTRIAL APPLICABILITY

Protein-enriched marshmallow products of the present general inventive concept reduce hunger and sugar cravings for most individuals wanting to lose weight. In addition, for adults seeking to gain muscle mass, one serving of protein-enriched marshmallows replaces a many whey protein shake mixtures before or after a workout. For children, one serving of protein-enriched marshmallows replaces a serving of sugar-based marshmallows as a snack. Substituting my protein-enriched marshmallows beneficially provides wholesome protein for healthy tissue growth without overly increasing their blood-sugar levels as traditional marshmallows would.

A protein-enriched marshmallow product is described. While the present subject matter is described in connection with an example of how to make it, the present subject matter is not limited to this example. On the contrary, alternatives, changes, and/or modifications will become apparent to a person of ordinary skill in the art after reviewing this patent specification. Thus, all such alternatives, changes, and/or modifications are to be viewed as forming a part of the present subject matter.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

Numerous variations, modification, and additional embodiments are possible, and, accordingly, all such variations, modifications, and embodiments are to be regarded as being within the spirit and scope of the present general inventive concept.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A protein-enriched marshmallow composition comprising:
water;
protein;
gelatin;
an emulsifier; and
a preservative agent.

2. The protein-enriched marshmallow composition of claim 1, wherein the protein is whey protein.

3. The protein-enriched marshmallow composition of claim 1, wherein the emulsifier includes at least one emulsifier selected from the group consisting of lecithin, lactic acid esters of mono and diglycerides, acetic acid esters of mono and diglycerides, polyglycerol esters, propylene glycol esters, polypropylene glycol esters, sucrose esters, lecithin, cellulose gum, microcrystalline cellulose, hydroxypropyl methylcellulose (HPMC), monoglycerides, and diglycerides, modified cellulose, lactic acid esters of mono- and di-glycerides, polysorbate 80, calcium stearoyl-2-lactylate, lactylic stearate, sodium stearoyl fumarate, and sodium stearoyl-2-lactylatewhey protein.

4. The protein-enriched marshmallow composition of claim 3, wherein the emulsifier includes polysorbate 80.

5. The protein-enriched marshmallow composition of claim 1, wherein the protein-enriched marshmallow composition includes 20-30 grams water, 18-24 grams protein, 4-5 grams gelatin, and 1-3 grams emulsifier.

6. The protein-enriched marshmallow composition of claim 5, wherein the protein-enriched marshmallow composition includes up to 3 grams artificial sweetener.

7. The protein-enriched marshmallow composition of claim 5, wherein the protein-enriched marshmallow composition includes up to 3 grams of flavoring agent.

8. The protein-enriched marshmallow composition of claim 5, wherein the protein-enriched marshmallow composition includes up to 3 grams corn starch.

9. The protein-enriched marshmallow composition of claim 5, wherein the protein-enriched marshmallow composition includes up to 6 grams of a vitamin.

10. The protein-enriched marshmallow composition of claim 5, wherein the protein-enriched marshmallow composition includes up to 6 grams of a mineral supplement.

11. A method of producing a protein-enriched marshmallow comprising:
mixing gelatin, water, and a preservative agent to form a water-preservative-gelatin mixture, the mass ratio of water to gelatin being at least 2.5:1;
after allowing gelatin within the water-preservative-gelatin mixture to absorb water within the water-preservative-gelatin mixture, heating the water-preservative-gelatin mixture to a temperature of 45 degrees Celsius to 65 degrees Celsius;
mixing protein, artificial sweetener, and food-grade emulsifier to form a protein-sweetener-emulsifier mixture;
combining the water-preservative-gelatin mixture with the protein-sweetener-emulsifier mixture and mixing thoroughly to form a marshmallow mixture;
cooking the marshmallow mixture to remove water until water content of the marshmallow mixture is from 25% to 35% of the total mass of the marshmallow mixture;
heating the marshmallow mixture at a temperature of 50 degrees Celsius to 55 degrees Celsius;
aerating the marshmallow mixture; and
extruding the aerated marshmallow mixture onto a corn starch bed.

12. The method of producing a protein-enriched marshmallow of claim 11 further comprising the step, before combining the water-preservative-gelatin mixture with the protein-sweetener-emulsifier mixture, adding liquid flavoring to the water-preservative-gelatin mixture.

13. The method of producing a protein-enriched marshmallow of claim 11 further comprising the step, before combining the water-preservative-gelatin mixture with the protein-sweetener-emulsifier mixture, adding at least one vitamin to the water-preservative-gelatin mixture.

14. The method of producing a protein-enriched marshmallow of claim 11 wherein the protein includes whey protein powder.

15. The method of producing a protein-enriched marshmallow of claim 11 wherein the emulsifier includes at least one emulsifier selected from the group consisting of lecithin, lactic acid esters of mono and diglycerides, acetic acid esters of mono and diglycerides, polyglycerol esters, propylene glycol esters, polypropylene glycol esters, sucrose esters, lecithin, cellulose gum, microcrystalline cellulose, hydroxypropyl methylcellulose (HPMC), monoglycerides, and diglycerides, modified cellulose, lactic acid esters of mono- and di-glycerides, polysorbate 80, calcium stearoyl-2-lactylate, lactylic stearate, sodium stearoyl fumarate, and sodium stearoyl-2-lactylate.
